(19) United States
(12) Patent Application Publication
(10) Pub. No.: US 2006/0173771 A1
(43) Pub. Date: Aug. 3, 2006

(54) Foreign currency exchange

(76) Inventor: Scott Lochwood Johnston, Oak Park, IL (US)

Correspondence Address: Paul E. Schaafsma;NovusIP, LLC, Suite 221, 521 West Superior, Chicago, IL, 60610, US

(21) Appl. No.: 11/048,994

(22) Filed: Feb. 2, 2005

(51) Int. Cl. G06Q 40/00

(52) U.S. Cl. 705/37; 705/39

(57) ABSTRACT

In accordance with the principles of the present invention, a system is provided to help link foreign exchange liquidity at a given settlement date. Exchange trade is represented as a positive product flow and a negative product flow relative to a side of the exchange trade. An exchange relationship between products is defined. A hierarchy of the products is defined. Cross rates to other foreign exchange products in the system are calculated. In accordance with the present invention, a system is provided to integrate spot/forward and swap markets. A forward event type and a swap event type are defined. In a database, spot and other designated dates are defined. Correct settlement dates for the named dates are determined. When an order is entered into the system, the order is entered into an order book, whereby settlement dates are aligned for transactions. In accordance with the present invention, a system is provided to match products in a swap. Products are matched against resting real orders. Products are then matched against resting implied orders with a prioritization scheme. For any residual resting order, implied markets are computed and again checked for matches. When new implieds are generated/checked, if the original order is a ‘spot’ order implieds are generated/checked first along a product axis, then along a date axis. For all other orders, implieds are generated/checked first along the date axis, then the product axis.

### FIELD OF THE INVENTION

The present invention relates to foreign currency exchange markets and the linkage of foreign currency markets to other traditional markets.

### BACKGROUND OF THE INVENTION

In a universe with a single currency, there would be no foreign exchange, no foreign exchange rates, and no foreign exchange market. But in our world of mainly national currencies, the foreign exchange market plays the indispensable role of providing the essential machinery for making payments across borders, transferring funds and purchasing power from one currency to another, and determining that singularly important price, the exchange rate. “Foreign exchange” refers to money denominated in the currency of another nation or group of nations: any person who exchanges money denominated in his own nation's currency for money denominated in another nation's currency acquires foreign exchange. “Foreign exchange market” refers to the international network of major foreign exchange dealers engaged in high-volume trading around the world. See generally, “All About . . . The Foreign Exchange Market in the United States,” published by the New York Federal Reserve available at http://www.newyorkfed.org/education/addpub/usfxm/

Foreign exchange (FX) markets suffer from a lack of automation and integration on many fronts. On one front, there is no seamless integration between trading in major currency pairs, such as U.S. Dollars and European Community Euros or U.S. Dollars and Japanese Yen, and ‘cross rates’ such as Yen/Euros. A cross rate can be defined as the exchange rate between two currencies, other than those that form a market's principal rates. For example, in the U.S., the Japanese Yen/EU Euro rate is a cross rate. Liquidity can be defined as the number of immediately tradable units of some product. The concept of linking liquidity between two related markets can be defined as the process of exposing synthetic, exchange or marketplace generated orders in one market by transforming one or more real orders, in one or more related markets. The nature of the transformation is dependent on liquidity linkage. Linking liquidity in a systematically consistent manner could improve the quality of all linked markets by combining the liquidity of the linked markets and broadcasting the greater available actionable quantities on all linked markets.

In addition, traditional markets cannot be seamlessly traded in a variety of foreign currencies. Take as an example the stock of Microsoft Corporation of Redmond, Wash. (symbol MSFT traded on the NASDAQ Stock Market, Inc., New York, N.Y. and a variety of Electronic Communications Networks (ECNs) in the U.S.). Many foreign investors need to convert their home currency into U.S. Dollars in order to buy or sell Microsoft stock. In order to accomplish this, a Swiss investor for example has to execute a variety of foreign exchange transactions or pay a significant currency translation fee to settle the stock trade.

It would be advantageous to provide a method to expose any market in any currency and to provide simultaneous and atomic order execution of both the primary market and the foreign exchange transaction. An atomic order execution can be defined to mean that an order, which may actually be a composite of a number of orders in various markets, is executed across all involved markets with little chance of execution risk (whether an order is executed or not) and price slippage (whether an order is executed at the expected price or something worse).

Further, foreign exchange markets lack seamless integration between the foreign exchange spot markets with the foreign exchange forward market. A forward contract is an agreement to buy or sell an asset at a certain future time for certain price. It can be a contrasted with a spot contract, which is an agreement to buy or sell an asset for immediate delivery. Market convention defines a spot transaction as an “immediate” delivery, but in reality, settlement or exchange of currency usually occurs two days after the transaction; thus spot is a two-day settled forward agreement. Forward markets generally describe certain common dates of settlement, such as a one-week, one-month or one-year settlement dates relative to the transaction date. These dates are determined by well-defined market conventions and are the prices that are most frequently quoted and traded, but any settlement date may be transacted if so desired. Given the large range of possible settlement dates and combinations of currencies, FX markets lack the seamless integration between the liquid spot market with the less liquid forward market.

Seamless integration between the foreign exchange spot market and the foreign exchange forward market is important as the two markets are linked through currency swap trades. A currency swap is an agreement to sell one currency for another in a spot transaction with the simultaneously agreement to re-exchange those currencies at a date in the future via a forward transaction. Currency swap trades are currently traded as a spread (price difference) between the spot rate and the forward rate. Linking liquidity between spot, forward, and swap markets would improve the quality and liquidity of all three markets.

Still further, foreign exchange markets lack a transparent method of properly matching settlement dates when exposing products traded in a foreign currency. Many products trade with settlement that differs from the traditional FX spot settlement of two days. For example, equity trades in the U.S. settle in three business days, compared to two business days for a normal spot transaction. In order to reflect the funding cost of the position and to facilitate proper credit and settlement risk control, it is important to match settlement dates of traded products and the currencies in which the traded products are transacted.

In addition, there is a growing need for a cleared foreign exchange forward market. Cleared foreign exchange forwards are very similar to foreign exchange futures as traded on regulated exchanges like the Chicago Mercantile Exchange, 20 South Wacker Drive, Chicago, Ill. The Commodity Futures Trading Commission (CFTC), a U.S. federal agency established by the Commodity Futures Trading Commission Act of 1974, regulates such exchanges. One attribute that would contribute to the success of a cleared forward market would be a mechanism to integrate the liquidity of a cleared forward market with liquidity that exists on a CFTC-regulated futures exchange. In markets where liquidity is linked, orders in one market are executable in another, and vice versa. The benefit of linked liquidity would be that each market would reflect the combined liquidity and customer interest of both the cleared forward market and the foreign exchange futures market. It would thus be advantageous to provide for a mechanism to link liquidity between these two markets, improving the quality and liquidity of each.

Finally, the method to expose any market in any currency can be generalized and provided as a service to a multitude of marketplaces, both domestic and international. These marketplaces can be organized exchanges, unregulated markets or other venues where customers of the market may use a principal currency that differs from the principal currency of the market. Customers will benefit by having immediately accessible markets in their home currency, while marketplaces will benefit by reducing the transaction cost and complexity for foreign customers; these benefits again would be expected to improve the liquidity of markets that utilize this service.

### SUMMARY OF THE INVENTION

A system in accordance with the principles of the present invention defines a consistent internal representation of markets that supports a systematic relationship between markets, constituent orders, resulting transactions, and market data. A system in accordance with the present invention better provides for liquidity to be linked across primary markets and cross-rate markets in a systematically consistent manner. A system in accordance with the present invention provides for a method to expose any market in any currency—and provides simultaneous and atomic order execution of both the primary market and the foreign exchange transaction.

A system in accordance with the present invention provides for a method to integrate spot, forward, and swap transactions. A system in accordance with the present invention helps integrate cleared forward markets and regulated foreign exchange futures markets, improving the quality and liquidity of each. A system in accordance with the present invention allows the centralization of much inefficiency borne by individual participants of the market, thus building new markets, improving the efficiency for users, and to offering new and valuable services to the market. A system in accordance with the present invention would provide a service to other markets that would benefit from having their products tradable in any currency.

In accordance with the principles of the present invention, a system is provided to help link foreign exchange liquidity at a given settlement date. An order is represented as a positive product flow and a negative product flow relative to conventions established for the target market by an exchange. An exchange relationship between products is defined. A hierarchy of the products is defined. Cross-rates to other foreign exchange products in the system are calculated, thus exposing the liquidity of the product in all available currencies.

In accordance with the principles of the present invention, a system is provided to integrate spot/forward and swap markets. A forward order type and a swap order type are defined. In a database, spot and other designated dates are defined. Correct settlement dates for the named dates are determined. When an order is entered into the system, the order is entered into a ‘target’ order book for a particular settlement date.

In accordance with the principles of the present invention, a system is provided to match products in spot, swap, forward, futures or any potential combination thereof. Products are matched against resting real orders for the original target market. Products are then matched against resting implied orders with a prioritization scheme. For any residual resting order after matching occurs, implied markets are computed and again checked for matches. When new implieds are generated and checked for potential matches, if the original order is a ‘spot’ order, implieds are generated and checked for potential matches along a product axis and along a date axis. For all other orders, implieds are generated and checked for potential matches first along the date axis, then the product axis. The prioritization and ordering of this process can be changed to optimally fit the market characteristics of the products being traded.

In accordance with the principles of the present invention, a system and method is provided to offer other markets the capability of trading their products in a variety of currencies. A mechanism is provided to the market to integrate spot, swap and product markets. A set of market makers for spot and swap markets is enlisted to contribute orders to the market, and a payment relationship is established between the customer entity, the target market, and the provider of the service to expose markets in various currencies.

### BRIEF DESCRIPTION OF THE DRAWINGS

FIG. 1 shows a non-limiting example of a high level implementation that can be used to run a system in accordance with the principles of the present invention.

FIG. 2 outlines attributes of market convention, which can vary per biproduct and per market, using a U.S. Dollar Swiss Franc example.

FIG. 3 shows a spreadsheet of a first example of a system in accordance with the principles of the present invention linking foreign exchange liquidity at a given settlement date.

FIG. 4 shows a spreadsheet of a second example of a system in accordance with the principles of the present invention linking foreign exchange liquidity at a given settlement date.

FIG. 5 sets forth product cash flows of an example resulting implied order.

FIG. 6 shows an example universe of three products in accordance with the principles of the present invention, with possible orders to trade biproducts in that universe.

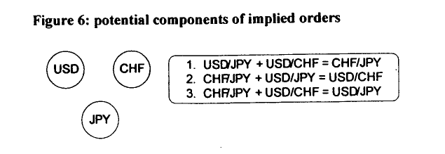

FIG. 7 shows an example of a three-tier universe in accordance with the principles of the present invention, with possible orders to trade biproducts in that universe.

FIG. 8 shows an example of a system in accordance with the principles of the present invention exposing product liquidity in multiple currency denominations.

FIG. 9 shows an example of a system in accordance with the principles of the present invention integrating spot/forward and swap markets, and aligning settlement dates for transactions.

FIG. 10 shows an example of a second-generation implied market system in accordance with the principles of the present invention.

FIG. 11 shows an example of a forward/futures implied market in accordance with the principles of the present invention.

### DETAILED DESCRIPTION OF THE INVENTION

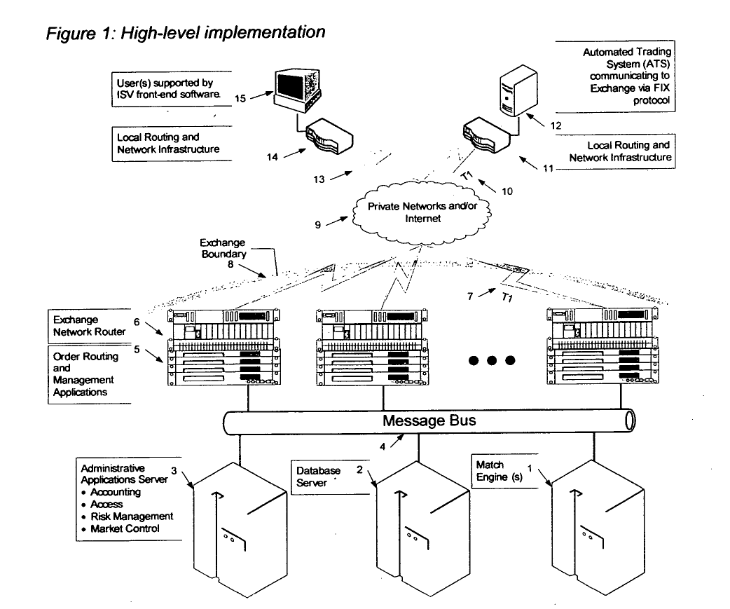

In one embodiment, a system in accordance with the principles of the present invention can be run on a hardware infrastructure. Referring to FIG. 1, a non-limiting example of a high level implementation that can be used to run a system of the present invention is seen. The infrastructure should include but is not limited to: wide-area network connectivity; network infrastructure; an operating system such as for example Redhat Linux Enterprise Linux AS Operating System available from Red Hat, Inc., 1801 Varsity Drive, Raleigh, N.C.; appropriate network switches and routers; electrical power (backup power); network backup hardware and software, and message software such as for example Tibco SmartSockets messaging software available from Tibco Software Inc., 3303 Hillview Avenue, Palo Alto, Calif.

The match engine (1), administrative applications server (3) can run for example on an HP Proliant DL740 server with 4 3.0 GHz processors, 64 GB or RAM, 60 GIG Raid level 1 and 1 GHZ network connection, available from the Hewlett-Packard Company, 3000 Hanover Street, Palo Alto, Calif. The database server (2) can be run for example on an HP Proliant DL740 server with 4 3.0 GHz processors, 64 GB or RAM, 300 GIG Raid level 3 and two 1 GHZ network connections, and an active backup system, capable of backing up and restoring while the system is active. The order routing and management applications (5) can be run for example on HP Proliant DL360 server with 2 3.6 GHz processors, 8 GB or RAM, 60 GIG Raid level 1 and 1 GHZ network connection, also available from the Hewlett-Packard Company. The match engine (1) receives orders, matches trades, and transmits market data related to trades, and orders to users. The match engine may be implemented with multiple algorithms to match orders and disseminate market data. The database server (2) includes information to identify traders, accounts, access information, order and trade history, and product data.

The administrative application server (3) contains modules or applications necessary to run an electronic exchange. An accounting module may be included to track firm and user accounts, report profit and loss, perform financial and accounting functions, and generate various reports. An access module may be included to control user access to the exchange, and products or functions of the exchange. A risk management module may be included manage and monitor user's risk utilization in relation to the user's risk thresholds. A market control module may be included to perform administrative market tasks such as for example managing market hours, performing settlement price calculations, implementing circuit breakers, and other control functions.

Order routing and management applications (5) manage the flow of orders and market data to/from users, verifies and translates various data streams, and implements various controls and functions to ensure a reliable connection to the exchange. Access to the exchange can be provided through the Financial Information eXchange (FIX) protocol. The FIX protocol is a public-domain specification owned and maintained by FIX Protocol, Ltd. developed for real-time electronic exchange of securities transactions. The message bus (4) is a software messaging system that facilitates communication of all elements of the system, as well providing a method for scalability, fault tolerance, and recovery. All of these hardware and software elements collectively form the exchange system, which is connected through exchange network routers (6) to various public (Internet) or private network carriers (9) via high-bandwidth telecommunications lines (7).

Exchange users may connect to the exchange through a variety of means and use a variety of methods to act as customers of the exchange. One or more users may access the exchange via third-party software solutions provided by Independent Software Vendors (ISVs) which, among other functions, allow the user to enter orders, view market data, and manage their trading positions. This software typically runs on a desktop workstation (15) and is connected to a private or public network (13) through local area network hardware (14).

Users may also access the exchange via automated trading systems (12) that run on servers and execute trades in an automated fashion. Automated trading systems functionality may also include market data and risk management functions. Automated trading systems are connected to a private or public network (10) through local area network hardware (11).

Initially, a system in accordance with the principles of the present invention defines a consistent internal representation of markets, which supports a systematic relationship between markets, constituent orders, resulting transactions, and market data. In general, exchange methods (and prior art exchange technology) treat a transaction as the transfer of currency for some unit of product, such as a share of stock, a contract-unit of futures, a notional amount of bonds, an amount of another currency or any other financial product. This prior art technique is also used in exchange-traded foreign exchange futures, where an example transaction in U.S. Dollars/Swiss Francs futures would involve exchanging a variable quantity of U.S. Dollars for a fixed contract unit of 125,000 Swiss Francs. This product/contract-oriented view of the prior art inhibits the ability of an exchange to flexibly link a transaction to other related transactions in other potential markets. The flexibility of the present invention allows consistent, dynamic creation of new product relationships and traded markets, which cannot be replicated by current technology.

In accordance with the principles of the present invention, to improve on the current model an order can be viewed as being represented as two product flows—one positive and one negative—which would mirror the cash and/or product movements should the order be executed and settled. Unlike a futures contract, each of these product flows can have a variable quantity. Within this realm, a product can be defined as any financial instrument such as for example a stock, bond, futures contract or a unit of foreign currency. Examples include: USD (U.S. Dollars), CHF (Swiss Francs), British Pounds (GBP), IBM stock, SPU4 (S&P 500 Index September 2004), JYU4 (Japanese Yen September 2004).

In accordance with the principles of the present invention, a biproduct, product hierarchy, calendar hierarchy, and product ordinality are provided. A biproduct can be defined as an exchange relationship between two products. In the internal representation, the denominator of the biproduct is the object of the action ‘buy’ or ‘sell’; the numerator is the exchanged for the denominator product. The ‘price’ of the exchange is the quantity of numerator product per one denominator product. A product hierarchy can be defined as which product will be the numerator and which will be the denominator in a biproduct relationship. In one embodiment, the product that is highest in the hierarchy will be the numerator product. Product ordinality can be defined as the order of hierarchy between products. The product ordinality defines a numerator/denominator relationship between products to ensure consistency in units and results. For convenience, the hierarchy is ordered roughly according to:
{asset class, product liquidity}.

Product and calendar hierarchies are necessary to support a consistent systematic relationship when calculating relationships between markets. These relationships can be linked through common products, common dates or both. This chosen ordering of hierarchies is only for internal representation; different orderings will not affect the outcome of the method. A product hierarchy can also be used to create a biproduct hierarchy, which could be used to order and prioritize actions involving biproducts such as order, transaction, and market data calculations.

Table 1, below, sets forth an example product hierarchy for Products Pₓ where

$$x = 0 to z ; price = \frac{numQty}{denQty} ; and \frac{{P}_{x}}{{P}_{y}} where ( x < y ) \text{:}$$

TABLE 1
Example Product Hierarchy

| Product | Ordinality | Description of Product |
|---|---|---|
| USD | 0 | U.S. Dollar Currency |
| CHF | 1 | Swiss Franc Currency |
| JPY | 2 | Japanese Yen Currency |
| AUD | 3 . . . | Australian Dollar Currency |
| ES | 100 | E-mini S&P Futures traded at the Chicago |
| | | Mercantile Exchange |
| ZD | 101 | Dow Jones Industrials average product derived |
| | | from the DOW index promulgate by Dow |
| | | Jones & Company, New York, New York |
| IBM | 1000 | Stock of IBM Corporation, White Plains, New |
| | | York |
| MSFT | 1001 . . . | Stock of Microsoft Corporation, Redmond, |
| | | Washington |
| ZB | 20000 . . . | 30 year U.S. Treasury Bond Future |

In one embodiment, the present invention uses date resolution of one day, but it would be possible to specify a date calendar with higher resolution to capture differences in settlement and expiration times around the world. Table 2 shows a calendar hierarchy—Time periods Tᵢ where i=0 to n:

TABLE 2
Example Calendar Hierarchy

| Date | Position in Hierarchy |
|---|---|
| 0 | 0 |
| 1 | 1 |
| 2 | 2 - typical spot settlement date |
| n | N |

A system in accordance with the present invention recognizes that both products (numerator and denominator) in a trade can contribute to other implied markets and can serve as numerator or denominator in other markets. In the defined internal data representation and consistent systematic relationship, ‘buy/sell’ refers to the denominator product. The product with lowest ordinality is highest in the hierarchy; and the ordinality of a biproduct is the sum of ordinalities of the constituent products. The system of the present invention facilitates a representation of a potential market in a way that maintains relationship consistency between component products of the immediate market, as well as markets related through common products. In accordance with the principles of the present invention, a new method of matching orders and disseminating market data that reflects this consistency can then be implemented.

In describing financial transactions, there will be a description that fits the ‘market convention’, and there will be another description that is internally consistent with the system of the present invention. The market convention represents the format and descriptive standards for a financial transaction in the local market. There will always be a translation between the two representations, and the system of the present invention will contain the data to be able to perform this translation. Internal representations are maintained so that all computations and operators are correct throughout. For any external data representation, a database of market conventions is kept per biproduct, and these are applied wherever necessary.

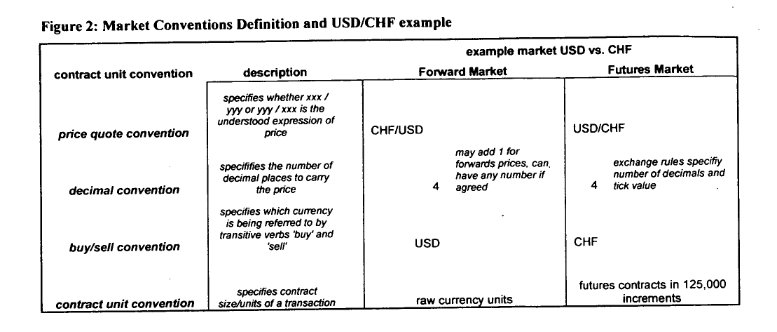

FIG. 2 outlines attributes of market convention, which can vary per biproduct and per market. Consider two USD/CHF markets—one a cleared forward market, the other a futures market, both with the same settlement date. To illustrate the example, a participant in the forward market might say “I buy 1 million at 1.2500”—meaning they buy 1 million USD and sell 1.25 million CHF. A participant in the Swiss Franc futures market sells 10 contracts at 0.8000. Both actions result in a positive cash flow in USD of 1,000,000 and a negative cash flow of CHF 1,250,000. The cash flows of these two transactions are the same, and are fungible through a common clearinghouse.

The system of the present invention links liquidity in related markets through implied orders. In general, an implied order is an order that can be internally constructed from two or more orders that exist in the order book. Because a system in accordance with the present invention models orders as cash flows (or product flows in the case of non-foreign exchange orders), any set of orders can be decomposed and reassembled so long as the cash flows are consistent. Prior art exchange technology considers an implied order to be constructed as a spread, or arithmetic relationship between two or more orders. This approach cannot be used to represent the liquidity-enhancing relationships described herein.

In addition to implieds, a system in accordance with the principles of the present invention provides for second-generation implieds. Second-generation implied markets refer to orders that are internally constructed from two or more orders which exist in the order book, where at least one of the orders are implied orders.

There are many possible implementations of computing and maintaining implied orders from an order book. In application to foreign exchange and other markets requiring internationalization, the concept of a placeholder order is used to represent the implied order. This placeholder order is internal to the system and is created to note the existence of a potential implied order, and is removed when the implied order ceases to exist—either because the orders that the implied is dependent on have changed, or an external order has arrived which matches against the implied order. To improve the speed and efficiency of the process, the matching process of the present invention will track dependent orders to a newly generated implied, and precedent orders to the newly generated implied (further implied orders that rely on the newly created implied order). This makes it straightforward for the system to take action whenever activity occurs that involves an implied order.

This product-based hierarchy of the present invention also facilitates the calculation of price and maximum executable quantities. A system in accordance with the present invention can directly calculate correct executable quantities. In general, the maximum executable quantity for an implied order is the minimum quantity that is simultaneously executable in each of the implied orders constituents.

The description of the system and method will focus on, but is not limited to, limit orders (an order to buy a specified quantity of a product at or below a specified price or to sell it at or above a specified price, called the limit price). The techniques described work for any prospective transaction or order type such as for example market orders, block trades, request-for-quote, indication-of-interest, etc.

For simplicity, the methods described to compute implied prices and link liquidity have focused on a single order or price in an order book. The examples consider only a single best bid or single best offer (known as the ‘top’ of the order book). In implementation, it is often necessary to apply these methods to multiple orders and/or multiple price levels in an order book.

In many instances, the transformation of one market to another through an implied relationship, a spread relationship or simply a difference in market convention will result in the rounding of prices from one market to another. When rounding is necessary, in one embodiment of the present invention bid prices are rounded down, and ask prices are rounded up. This ensures that the transformed markets are executed at prices equal to or better than the raw transformed price.

In addition, a system of the present invention helps link foreign exchange liquidity at a given settlement date. Over-the-counter (OTC) foreign exchange spot and foreign exchange outright trading involve the purchase of some amount of base currency for an agreed amount of contra currency, for settlement at a particular settlement date. In the case of a foreign exchange spot trade, settlement is generally two days (a 2-day forward). A foreign exchange forward trade can have settlement anywhere from one day up to any date in the future.

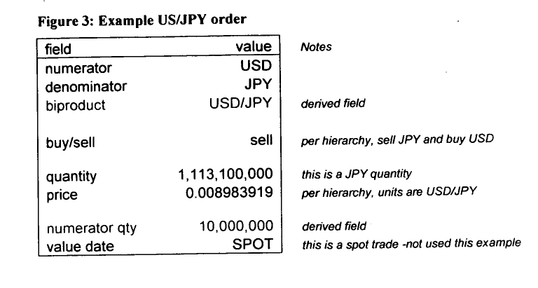

In a first example, the market receives an order to buy $10 million USD/JPY spot FX (foreign exchange) at 111.31. The spreadsheet for this example set forth in FIG. 3 shows the representation of an order (bid) to buy $10 million USD/JPY spot FX at 111.31. This means that U.S. Dollars will be bought, JP Yen sold at a rate of 111.31, and this transaction will be done for up to 10 million Dollars or 1,113,100,000 Yen. The representation in accordance with the principles of the present invention of this order is:
USD—the U.S. Dollar product
JPY—the Japanese Yen product
   The biproduct in accordance with the present invention is USD/JPY because USD is highest in the hierarchy; USD will be the numerator to JPY. The price of this transaction will be internally represented in units of USD per JPY, or
0.00898392.
   The total quantity available as defined in JPY is 1,113,100,000 JPY for 10,000,000 USD.

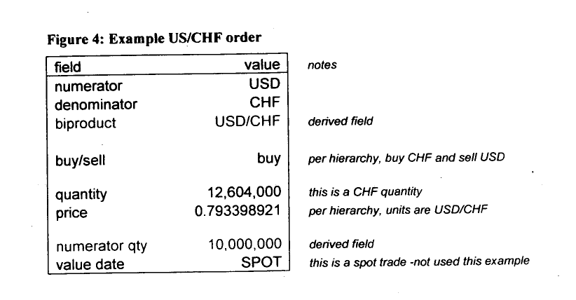

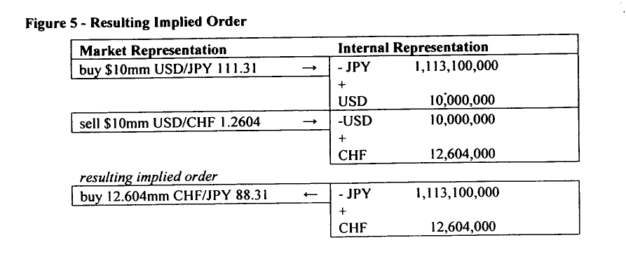

In a second example, the market receives an order to sell $10 million USD/CHF spot FX at 1.2604. Again, a system in accordance with the principles of the present invention defines USD as the numerator of the biproduct; the spreadsheet for this example is set forth in FIG. 4. These two example orders imply the existence of a third order—an implied order to buy CHF and sell JPY. FIG. 5 sets forth the product cash flows to show that the USD components cancel out, leaving an implied order for CHF/JPY.

Provided a consistent internal representation and the defined hierarchy are used, an implied cross rate can be derived as described below:

$$order1 = \frac{numerator1}{denominator1}$$

$$order2 = \frac{numerator2}{denominator2}$$

$$where ordinality ( order1 ) < ordinality ( order2 )$$

$$if ( numerator1 ≡ numerator2 )$$

$$or ( denominator1 ≡ denominator2 )$$

$$crossrate = \frac{order2 \cdot price}{order1 \cdot price} \\ else \\ crossrate = order1 \cdot price * order2 \cdot price$$

The calculation to determine maximum available implied quantity (in denominator product terms) is described below:

$$if ( numerator1 ≡ numerator2 )$$

$$maxQuantity = \frac{\begin{matrix}min ( numerator1 \cdot quantity , \\ numerator2 \cdot quantity )\end{matrix}}{crossrate}$$

$$else$$

$$\begin{matrix}maxQuantity = min ( denonimator1 \cdot quantity , \\ denominator2 \cdot quantity )\end{matrix}$$

Unlike prior art exchange models, a method in accordance with the present invention does not make a functional distinction between numerator and denominator of an order. The method of the present invention allows both numerator and denominator products to participate in all relationships that involve either of the two products. Referring to FIG. 5, for instance, this is seen in the contribution of USD/CHF orders to create the implied CHF/JPY order book. In addition, a match process in accordance with the present invention works for any two products, only limited by practical application (for example, while there is little market for product swap or barter markets, a method in accordance with the present invention would nevertheless work).

As orders enter the system in accordance with the present invention, it may be desirable to normalize the orders against a reference currency to optimize the match operation. A normalized order book may be the fastest means to determine if the incoming order creates a matched trade. As a single match can involve a large number of orders on both sides of the transaction, normalization may improve the performance of matching. It would be necessary to keep normalization factors for each product versus a universal product (currency)—it would likely be optimal to normalize ‘up’ the hierarchy. The hierarchy may be changed based on expected ‘most liquid’ currency ordering at different times of the day, or via actual computed liquidity that exists in the order book instantaneously. Also, some groups of products may form spanning trees that are disassociated with the ‘main’ tree (USD root). The normalization method will account for this by normalizing to the currency highest in the spanning tree hierarchy.

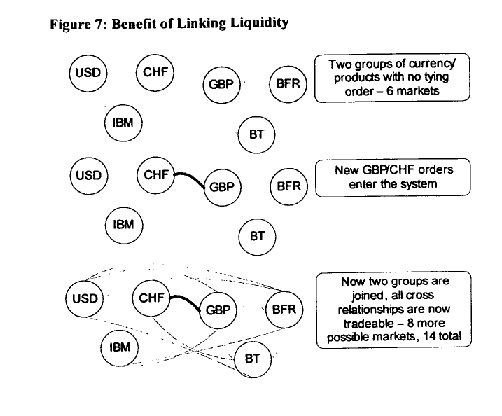

Referring to FIG. 7, some of the benefits of linking markets in accordance with the present invention are seen. In a first tier, ‘A’, two groups of currency products are shown with no tying order—this results in six markets. In a second tier, ‘B’, new GBP/CHF orders enter into the system of the present invention. Now two groups are joined, and cross relationships are now tradable: a third tier, ‘C’, shows eight more possible markets, 14 in total. Thus, linking markets in accordance with the present invention results in more liquidity in more products.

It will be the case that sometimes the method of the present invention will have the opportunity to choose between alternative sources of liquidity when filling an order—such as matching USD/CHF against resting orders for CHF/JPY+USD/JPY=USD/CHF and EUR/CHF+USD/EUR=USD/CHF, as well as resting USD/CHF orders. There are many alternatives the method of the present invention could use to resolve the trade: different methods may be appropriate at different times and under different conditions. Alternatives can include, but are not limited to: FIFO (match in order of age of order—first into the book matches); allocation matching (prioritize match by order size); product hierarchy; match orders of the same original biproduct first, followed by any subsequent orders; etc. The match process may or may not use placeholders to track potential liquidity in related products. The match process may or may not use placeholders to compute liquidity in any cross relationship that has no real orders on the book (indicating this might not be a relationship that is of any interest to the market). The match process may or may not use second order implied (and greater) relationships to fill liquidity.

In addition, a system in accordance with the principles of the present invention helps expose product liquidity in multiple currency denominations—this is referred to as foreign exchange internationalization. Consider for example an exchange that lists a highly liquid, USD-traded product such as an NASDAQ-100 Index Tracking Stock (symbol QQQ). The NASDAQ-100 Trust Series I is a pooled investment designed to provide investment results that generally correspond to the price and yield performance of the NASDAQ-100 Index. A Swiss investor wishing to purchase a share of QQQ would have to convert Swiss francs to USD in order to execute and settle the transaction, and would be subject to USD/CHF risk between executing the QQQ trade and executing the USD/CHF FX spot transaction. Using principles in accordance with the present invention as described above, the QQQ share can be defined as another product in the hierarchy with ordinality lower than all the currency products. This results in QQQ being the denominator in the internal representation of the present invention. Finally, in one embodiment cross rates are restricted from being derived on the products that are not currencies.

The result will be that any USD/currencyProduct market introduced into the system will immediately calculate cross rates to all other currency products in the system, thus exposing the liquidity of the product in all available currencies. As with cross rates, execution of these currencyProduct/product orders will internally result in simultaneous execution of the USD/product and USD/currencyProduct orders, but will give the user of the market back a single transaction of currencyProduct for product.

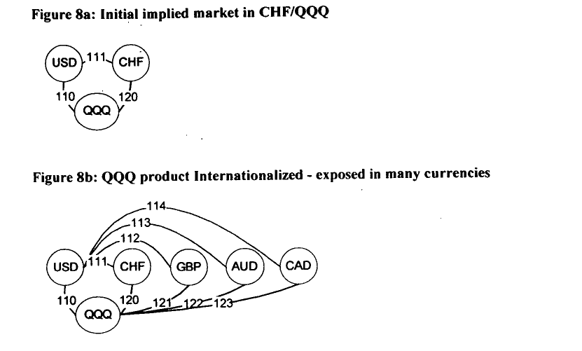

Referring to FIG. 8a, consider a sequence where (step 1) a market in USD/QQQ (110) is entered into system. A market in USD/CHF (111) is entered into system (step 2). Once these two orders are in the system, (step 3) an immediate implied market of CHF/QQQ (120) is available. As seen in FIG. 8b, the addition of USD/GBP, USD/AUD, USD/CAD markets (112,113,114) implies additional executable orders in GBP/QQQ, AUD/QQQ, CAD/QQQ (121,122,123).

In steps 1-3 of this example, the method of the present invention allows a foreign exchange spot transaction (USD/CHF) to be paired with a USD/QQQ transaction to create a single CHF/QQQ transaction. If the settlement date for the USD/QQQ transaction is the same as spot (e.g. delivery in two days), then product flows are both equivalent and properly settled on the same date. If the settlement date for the USD/QQQ transaction is not the same as spot, for instance as this is an equity transaction with settlement in three days, an additional embedded transaction would be needed to properly align the settlement dates and compensate for the cost of carrying the foreign exchange position in the transaction.

A system in accordance with the principles of the present invention helps integrate spot/forward and swap markets, aligning settlement dates for transactions. The relationship between spot, forward, and swap transactions can be summarized as set forth below:
Spot_{bid}+Swap_{bid}=Forward_{bid}
Spotₐₛₖ+Swapₐₛₖ=Forwardₐₛₖ
These relationships can be rearranged to derive implied orders for any one variable.

In accordance with the principles of the present invention, two distinct order types are defined: a forward order refers to an agreement to exchange an agreed upon amount of currency verses a second agreed upon amount of another currency at an agreed upon date in the future. The distinction between ‘spot’ and any other forward is just the settlement date. A swap order refers to an agreement to simultaneously execute a forward trade and a spot trade (the spot transaction has the opposite product flows of the forward). A swap will have a near and far settlement date. Generally (but not exclusively) the near date will be the ‘spot’ settlement date. Swap orders with two non-spot settlement dates are considered valid. A database is provided that contains definitions of spot and other designated dates that have special meaning to the forward markets (such as ‘1 month’). This database is used to determine the correct settlement dates for these named dates (which vary per biproduct). When an order is entered into the system, the order will be entered into the order book for that {biproduct, settlement date}.

In one embodiment, matching in accordance with the present invention could proceed as follows: match against resting real orders; match against resting implied orders with the appropriate prioritization scheme; for any residual resting order, compute implied markets and again check for potential matches; when generating and checking new implieds, if the original order is a ‘spot’ order, generate and check implieds along the product axis, then proceed along the date axis; for all other orders generate and check implieds first along the date axis, then the product axis.

As implieds are generated, placeholder orders are entered into the book, with a reference to the original (real) order that is the basis for the implied order. The real order also contains all references to implied orders in the system that depends on the real order. This bidirectional system of references improves the speed and efficiency of the market implementation. Refinements to the order of the ‘generate’ and ‘check’ steps may be order type or biproduct specific.

As matches occur, confirmation data is sent to appropriate counter parties. Once the match cycle is complete, market data is sent to ‘the market’ (widely distributed). It is possible to send multiple forms of data—for example the system could send one market data stream with all real and implied orders and another market data stream with just real orders. The second data stream will be much smaller and have significantly fewer update events, but requires the end user to correctly impute the implied orders from the data. Another technique in accordance with the present invention to manage the volume of market data generated would be to ‘snapshot’ the market data stream—which means send incremental updates at a periodic rate (for instance, twice per second), and not attempt to stream market data events in real time.

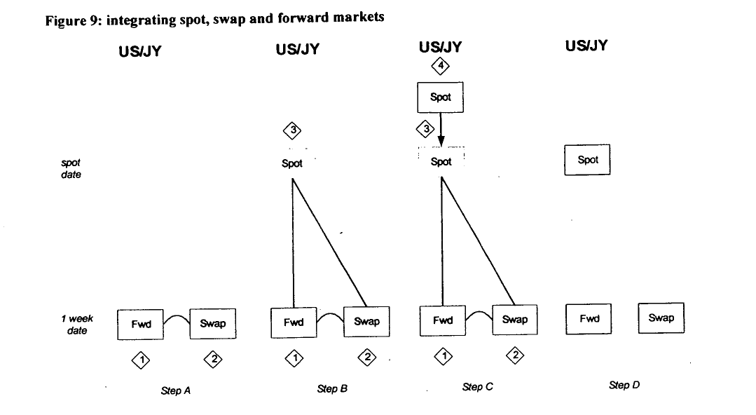

FIG. 9 shows an example of a system in accordance with the principles of the present invention integrating spot/forward and swap markets, thus aligning settlement dates for transactions. In step A: $10 mm USD are bought and JPY forward outright is sold (settlementDate=1 week); and $10 mm USD is bought and JPY swap is sold (settlementdate=1 week). In step B, $10 mm USD is bought and JPY are sold outright (settlementDate=2 days (spot)) (This implies a third order in the system). In step C, $10 mm USD are sold and JPY are bought outright (settlementDate=2 days (spot)). This order matches against the implied order #3. In step D, the real order #4 matches against implied #3, which causes orders #1 and #2 to be matched as well. All orders are matched, leaving no residual orders in the system.

A system in accordance with the principles of the present invention helps align settlement dates of financial transactions transacted in foreign currency. The method for implementing a market that integrates spot/forward and swap markets has been described. This method facilitates the integration of spot/forward/swap markets in such a way that links and expands the liquidity in each market, and provides atomic transactions for implied markets, which reduces execution risk. Because of the design of the system of the present invention, this method also facilitates internationalization: the integration of foreign exchange conversion and funding for non-foreign exchange transactions as well.

Consider the following example. A Swiss investor wishes to purchase IBM shares for her portfolio. Among the many markets in the system, Table 3 shows three that are required for her transaction—each market is supported by different participants for different purposes:

TABLE 3
Markets required to expose CHF/IBM

| biproduct | bid | bidQty | ask | askQty |
|---|---|---|---|---|
| USD/IBM | 100.35 | 20,000 | 100.55 | 20,000 |
| USD/CHF spot | 1.2594 | 10,000,000 | 1.2604 | 10,000,000 |
| USD/CHF 2-3swap | −0.0002 | 35,000,000 | −0.0001 | 35,000,000 |

A system in accordance with the principles of the present invention is able to put these markets together: USD/IBM, which settles in three business days; USD/CHF spot foreign exchange, which settles in two business days; USD/CHF three day swap (into spot). A system in accordance with the principles of the present invention then automatically links the equity, spot, and swap markets to create a new CHF/IBM implied market that settles in three days. The Swiss investor sees the result in Table 4:

TABLE 4
Resulting CHF/IBM market as viewed by Swiss Investor

| biproduct | bid | bidQty | ask | askQty |
|---|---|---|---|---|
| CHF/IBM | 126.3607 | 20,000 | 126.7232 | 20,000 |

The investor then purchases 10,000 shares of IBM, and the system returns a single trade ticket for IBM shares traded in CHF. Internally, however, the system has executed the trades shown in Table 5:

TABLE 5
Internal transactions necessary to complete CHF/IBM trade

| settlement | | | | Ticket #, |
|---|---|---|---|---|
| date | IBM | USD | CHF | transaction type |
| 3 days | 10,000 | $(1,005,500) | | 1. stock transaction |
| 3 days | | $1,005,500 | (1,267,232) | 3. swap transaction |
| 2 days | | $(1,005,500) | 1,266,327 | |
| 2 days | | $1,005,500 | (1,266,327) | 2. spot transaction |

The first ticket is the equity purchase, traded in the home currency of USD—this transaction settles in three days. The second ticket is the USD/CHF spot trade (the most liquid USD/CHF currency conversion market). This trade is done for the exact notional amount of USD required to buy IBM shares. The third ticket is a foreign exchange swap trade that swaps the USD amount from the spot foreign exchange settlement date (two day) to an equity settlement date (three days). Note how the USD amount in all settlement dates net to zero, as do all CHF amounts in the two-day settlement date. A negative CHF balance is left in three days, with an offsetting positive balance of 10,000 IBM shares. In accordance with the present invention, if any orders were entered directly in CHF/IBM or in three day forward USD/CHF, the system would have incorporated those into the transaction chain automatically.

The complete set of trade tickets generated are shown in Table 6:

TABLE 6
Complete summary of transactions behind example CHF/IBM transaction

| biproduct | Date | account | counterparty | buy/sell | qty | price |
|---|---|---|---|---|---|---|
| CHF/IBM | 3 day settle | SwissInvestor | EXCHANGE | buy IBM | 10,000 | 126.7232 |
| CHF/IBM | 3 day settle | EXCHANGE | SwissInvestor | sell IBM | 10,000 | 126.7232 |
| | | | | Sell | | |
| USD/CHF | 3day-2day swap | EXCHANGE | SwapMktMaker | USD | $1,005,500 | −0.0002 |
| | | | | Buy | | |
| USD/CHF | 3day-2day swap | SwapMktMaker | EXCHANGE | USD | $(1,005,500) | −0.0002 |
| | | | | Buy | | |
| USD/CHF | Spot | EXCHANGE | SpotMktMaker | USD | $1,005,500 | 1.2594 |
| | | | | Sell | | |
| USD/CHF | Spot | SpotMktMaker | EXCHANGE | USD | $1,005,500 | 1.2594 |

Because the exchange of the present invention serves as an intermediary between the various transactions, the Swiss investor receives one net ticket. The exchange is counterparty to all component transactions required to assemble the end-user transaction.

The previous example focused on securities trading, which is predominantly traded at 100% of the value of the transaction (if the security costs $100, the buyer pays all $100 to settle the transaction). The method of the present invention will also work for margined transactions, where some fraction of the total value is due upon settlement of the trade. A modification to the method is necessary to facilitate margin trading, which is to include the expected cost due at settlement as part of the original order—this is generally expressed as a percentage of the total unit cost of the trade, but other methods can be used. Upon execution of the transaction, the expected cost data would be used to compute the total amount of foreign currency due at settlement, and execute appropriate spot and forward transactions to consummate the transaction. Table 7 shows the effect on the previous example transaction with at 20% initial margin rate—the required foreign exchange transactions would be scaled to 20% of the total notional amount:

TABLE 7
CHF/IBM transaction at 20% margin rate

| settlement | | | | Ticket #, |
|---|---|---|---|---|
| date | IBM | USD | CHF | transaction type |
| 3 days | 10,000 | $(201,100) | | 1. stock transaction |
| 3 days | | $201,100 | (253,446) | 3. swap transaction |
| 2 days | | $(201,100) | 253,265 | |
| 2 days | | $201,100 | (253,265) | 2. spot transaction |

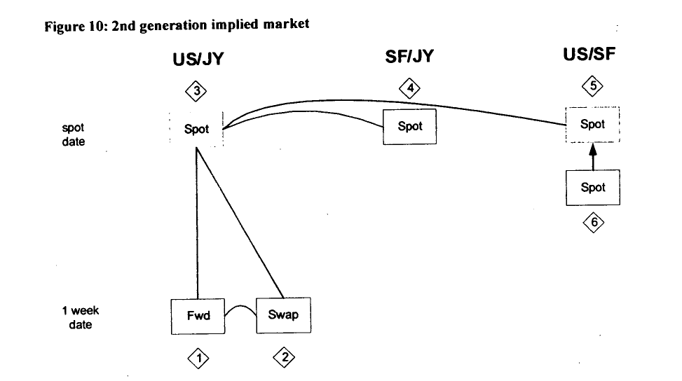

In addition to the implied market, a method in accordance with the principles of the present invention provides for a second-generation market. FIG. 10 shows a second-generation implied market in accordance with the present invention. There are a number of ways to implement this capability incorporating the methods and calculations described. One solution is to generate bidirectional placeholders as described in the description of first-generation implied orders.

A system of the present invention helps integrate foreign exchange futures market to foreign exchange spot/forward/swap markets. A foreign exchange future is a standardized, transferable, exchange-traded contract that requires delivery of a specified amount of foreign currency at a specified price on a specified future date. For an exchange that trades both currency futures and cleared forward contracts, a relationship between the two contracts can be established such that the two contracts are fungible (exchangeable through the clearinghouse for one another). Given this fungibility, it is also possible to implement a system by which orders in a futures contract market can match against orders in a corresponding forwards contract.

A regulated futures contract has a number of constraints that must be considered when creating a mechanism to perform intramarket matching between a cleared forward market and a currency futures market. First, exchange-traded currency futures are traded in contract units; the amount of foreign currency represented by one futures contract varies by currency. For example, foreign currency futures traded on the Chicago Mercantile Exchange have Exchange-traded Swiss Franc currency futures contracts with a value of 125,000 Swiss Francs; a Japanese Yen futures contract represents 12,500,000 Japanese Yen, and the Canadian Dollar future represents 100,000 Canadian Dollars. Therefore, when calculating how many equivalent futures are implied by a cleared forward at the same settlement date as the future, it is necessary to round down to the nearest whole contract. There is no similar constraint when implying a cleared forward market from a futures market, as forwards trade in increments of single currency units. Because of this contract units mismatch between similar markets, the situation will arise where a futures order matches against a forward order and leaves a small residual order on the side of the forward market. It would be desirable to set a minimum market size per currency pair, and if residual orders fall below that size, they are cancelled. This will improve performance of the system and simplify the market data for users.

Another constraint is that exchange-traded futures may trade in predefined units, called ticks. This creates a situation where converting prices between a cleared forward market and a futures market may result in a fractional futures price—this problem can be exacerbated when quoting conventions between the two related markets are inverted (USD/CHF is quoted in Swiss Francs per U.S. Dollar in the forward market, but is quoted in U.S. Dollars per Swiss Franc at the Chicago Mercantile Exchange). The solution to this situation varies depending on which market is matching implied orders.

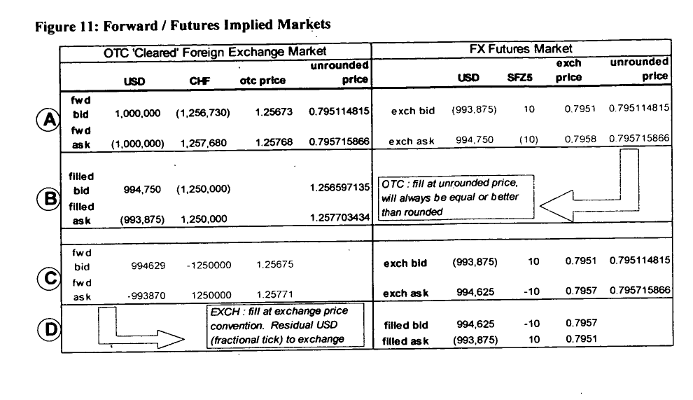

FIG. 11 illustrates a method for integrating liquidity between a cleared forwards market and a foreign exchange futures market in accordance with the principles of the present invention. The method specified accounts for differences in price and quantity definitions between a futures market and a forward market.

In a first example (denoted by the label ‘A’) a bid and ask market is provided in the cleared forward market. For this example, the settlement date of the example forward market corresponds to the settlement date for the December 2005 USD/CHF futures market. The bid for 1,000,000 USD at 1.25673 corresponds to an offer to sell 10 USD/CHF futures at 0.7958. The correct result is obtained because the method of the present invention specifies that cash flows of buying the forward (buy USD, sell CHF) are equivalent to selling the future (sell CHF, buy USD)—the units of each market are normalized by converting the CHF amount of the forward (1,256,730) into CHF futures contracts (1,250,000 CHF=10 futures contracts, fractional contract units are truncated). The price of 0.7958 is obtained by inverting the forward price (different price conventions between these two markets), and rounding to the nearest futures price (price convention standards are unique per currency pair and per market—these are stored in a database for final display). For any market convention there should be one consistent rounding rule: in one embodiment of the present invention, bids are rounded down, and offers are rounded up.

If this implied order to sell 10 futures was matched with an order to buy 10 futures, then the transactions in Table 8 would be generated (labeled ‘B’):

TABLE 8
Implied Matching - Futures to Forwards

| biproduct | date | account | counterparty | buy/sell | qty | price | USD amt | CHF amt |
|---|---|---|---|---|---|---|---|---|
| USD/CHF | SFZ5 | FuturesCustomer | EXCHANGE | buy | 10 | 0.7958 | (994,750) | 1,250,000 |
| | | | | CHF | | | | |
| USD/CHF | SFZ5 | EXCHANGE | FuturesCustomer | sell | 10 | 0.7958 | 994,750 | (1,250,000) |
| | | | | CHF | | | | |
| USD/CHF | Dec. 21, 2005 | EXCHANGE | ForwardCustomer | sell | 994,750 | 1.2565971 | (994,750) | 1,250,000 |
| | | | | USD | | | | |
| USD/CHF | Dec. 21, 2005 | ForwardCustomer | EXCHANGE | buy | 994,750 | 1.2565971 | 994,750 | (1,250,000) |
| | | | | USD | | | | |

The exact price (or exact inverted price, depending on market conventions) will be returned in the forward market transactions; this yields a match of the futures-side cash flows. Because of the rounding rules specified in the method, the forward price returned as a result of a match will be equal to or better than (from the customer's perspective) the forward price as displayed in the book with using forward market price display conventions.

Linking liquidity from a futures market into a forward market has a different solution. In a second example (labeled ‘C’ in FIG. 11), there is an order to buy 10 futures at a price of 0.7951. By defining this order in terms of cash flows, the order can be converted into an order to buy CHF and sell USD at a price of 1.25771 using the forward market price conventions and rounding conventions (down for offers, up for bids). The quantity of Swiss Francs represented in the forward market is the same amount as covered by 10 USD/CHF currency futures contracts; the USD amount of the forward is the same amount indicated by the forward price.

If this implied order to sell is matched in the forward market, then the transactions in Table 9 would be generated (labeled ‘D’):

TABLE 9
Implied Matching - Forwards to Futures

| biproduct | date | account | counterparty | buy/sell | qty | price | USD amt | CHF amt |
|---|---|---|---|---|---|---|---|---|
| USD/CHF | Dec. 21, 2005 | ForwardCustomer | EXCHANGE | buy | 993,870 | 1.25771 | 993,870 | (1,250,000) |
| | | | | USD | | | | |
| USD/CHF | Dec. 21, 2005 | EXCHANGE | ForwardCustomer | sell | 993,870 | 1.25771 | (993,870) | 1,250,000 |
| | | | | USD | | | | |
| USD/CHF | SFZ5 | EXCHANGE | FuturesCustomer | sell | 10 | 0.7951 | 993,875 | (1,250,000) |
| | | | | CHF | | | | |
| USD/CHF | SFZ5 | FuturesCustomer | EXCHANGE | buy | 10 | 0.7951 | (993,875) | 1,250,000 |
| | | | | CHF | | | | |

The futures price returned will be the original price of the futures order—this is because market convention does not allow fractional futures prices (should that happen in conversion). In one embodiment, the residual amount lost due to rounding will accrue to the exchange—this is not expected to amount to much—but choosing to allow it to accrue to the market would create an arbitrage condition that would be exploited. Should this condition become unacceptable to the market and a rule change was approved, an expanded number of decimals allowed in the futures price would alleviate this problem.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. A system which supports a systematic relationship between markets, constituent orders, resulting transactions, and market data, comprising:
establishing a consistent internal data model which represents orders and transactions as a series of flows;
defining a hierarchical relationship between products;
defining a hierarchy of dates; and
defining a system to derive implied and spread markets.

2. The system of claim 1 further including defining a biproduct as the exchange relationship between two products.

3. The system of claim 1 further wherein defining the exchange relationship comprises defining a denominator that is the object of the action ‘buy’ or ‘sell’ and defining a numerator that is the exchanged for the denominator product.

4. The system of claim 1 further including establishing a consistent internal data model that represents orders and transactions as a series of product flows.

5. The system of claim 4 further wherein the product flows can have a variable quantity.

6. The system of claim 4 further including relating the numerator or denominator product flows to numerator or denominator product flows of other byproducts.

7. The system of claim 6 further including not making a functional distinction between numerator and denominator of an order.

8. The system of claim 1 further including establishing a consistent internal data model that represents orders and transactions as a series of currency flows.

9. The system of claim 1 further including defining a price of the exchange as a quantity of a numerator product per a denominator product.

10. The system of claim 9 further including defining the price of the exchange as the quantity of one numerator product per one denominator product.

11. The system of claim 1 further wherein defining the hierarchy of the products comprises defining which product will be the numerator and which product will be the denominator in the exchange relationship.

12. The system of claim 11 further including defining the product that is highest in the hierarchy as the numerator product.

13. The system of claim 11 further including defining the order of preference between products.

14. The system of claim 13 further including defining the product with lowest ordinality as highest in the hierarchy.

15. The system of claim 13 further including defining the ordinality of a biproduct as the sum of ordinalities of the constituent products.

16. The system of claim 1 further wherein defining the hierarchy of dates comprises defining the order of market calculations to be grouped and ordered according to settlement date.

17. The system of claim 1 further including defining a relationship between markets to transform orders, transactions, and market data from one market to another.

18. The system of claim 17 further including defining a system to transform flows of one market to an equivalent or proportional set of flows in another market.

19. The system of claim 17 further including defining the maximum executable quantity of the transformed market as the minimum quantity which is simultaneously executable in each of the constituent markets.

20. The system of claim 1 further including creating a database of external market conventions to reconcile with local standards and conventions.

21. A system to link foreign exchange liquidity at a given settlement date, comprising:
calculating implied markets from related markets;
deriving implied liquidity;
adding the implied liquidity to original liquidity for each market; and
matching trades.

22. The system of claim 21 further including deriving an implied cross rate.

23. The system of claim 22 further including deriving an implied cross rate in accordance with the following relationship between biproducts:
$$Biproduct \frac{{P}_{i}}{{P}_{j}} = \frac{{P}_{i}}{{P}_{x}} \times \frac{{P}_{x}}{{P}_{j}}$$
or, for two levels of indirection:
$$Biproduct \frac{{P}_{i}}{{P}_{j}} = \frac{{P}_{i}}{{P}_{x}} \times \frac{{P}_{x}}{{P}_{y}} \times \frac{{P}_{y}}{{P}_{j}}$$
where Pᵢ and Pⱼ are the numerator currency and denominator currency or product respectively and Pₓ is another currency.

24. The system of claim 22 further including deriving an implied cross rate order in accordance with:
$$order1 = \frac{numerator1}{denominator1}$$
$$order2 = \frac{numerator2}{denominator2}$$
$$where ordinality ( order1 ) < ordinality ( order2 )$$
$$if ( numerator1 ≡ numerator2 )$$
$$or ( denominator1 ≡ denominator2 )$$
$$crossrate = \frac{order2 \cdot price}{order1 \cdot price} \\ else \\ crossrate = order1 \cdot price * order2 \cdot price$$

25. The system of claim 21 further including determining a maximum available implied quantity available for the cross rate order.

26. The system of claim 25 further including determining a maximum available implied quantity available for the cross rate order in accordance with:
$$if ( numerator1 ≡ numerator2 )$$
$$maxQuantity = \frac{\begin{matrix}min ( numerator1 \cdot quantity , \\ numerator2 \cdot quantity )\end{matrix}}{crossrate}$$
$$else$$
$$\begin{matrix}maxQuantity = min ( denonimator1 \cdot quantity , \\ denominator2 \cdot quantity )\end{matrix}$$

27. The system of claim 21 further including the creation of placeholders for implied orders, which represent the cash-flow equivalent combination of two or more markets.

28. The system of claim 21 further including normalizing orders against a reference currency.

29. The system of claim 28 further wherein normalizing orders against a reference currency comprises changing the hierarchy based on expected most liquid currency ordering at different times.

30. The system of claim 28 further wherein normalizing orders against a reference currency comprises changing the hierarchy based on expected most liquid currency ordering via actual computed liquidity that exists in the order book.

31. The system of claim 21 further including choosing alternative sources of liquidity when filling an order.

32. The system of claim 31 further wherein choosing alternative sources of liquidity when filling an order are selected from the group comprising match in order of age of order—first into the book matches; prioritize match by order size; product hierarchy; match orders of the same original biproduct first, followed by any subsequent orders; and combinations thereof

33. A system to expose various markets in multiple currency denominations, comprising:
defining the market as a product having a numerator and a denominator;
calculating implied cross rates from existing foreign exchange markets to the denominator of the market; and
restricting the market from cross rate calculations that would place it in the numerator of the biproduct.

34. The system of claim 33 further including defining another product in the hierarchy with ordinality lower than the currency products.

35. The system of claim 34 further including defining the product in the hierarchy with ordinality lower than the currency products as the denominator.

36. The system of claim 33 further including restricting cross rates from being derived on two products which are not currencies.

37. The system of claim 33 further including not making a functional distinction between numerator and denominator of an order.

38. A system to integrate spot, forward and swap markets, comprising:
defining a forward order type and a swap order type and their relationship to a spot transaction; and
using a date hierarchy to augment the priority and process of matching.

39. The system of claim 38 further wherein defining a forward order type comprises defining an agreement to exchange an agreed upon amount of currency verses a second agreed upon amount of another currency at an agreed upon date in the future.

40. The system of claim 38 further wherein defining a swap order type comprises defining a near and far settlement date.

41. The system of claim 40 further wherein defining a swap order type comprises defining a near and far settlement date, with the near date normally comprising a ‘spot’ settlement date.

42. The system of claim 38 further including deriving various linked markets in accordance with the following relationship between the three markets:
Spot_{bid}+Swap_{bid}=Forward_{bid}
Spotₐₛₖ+Swapₐₛₖ=Forwardₐₛₖ

43. The system of claim 38 further including matching markets related through time.

44. The system of claim 43 further including matching against resting real orders of the original order type and settlement date(s).

45. The system of claim 44 further including matching against resting implied orders with a prioritization scheme which incorporates the date hierarchy.

46. The system of claim 45 further including, if the original order was a spot order, matching and generating implied orders first within the spot settlement date and then the non-spot settlement date.

47. The system of claim 45 further including, if the original order was not a spot order, matching and generating implied orders first within the originating order's settlement date and then the spot settlement date.

48. A system to expose a market in multiple currencies with proper settlement dates comprising:
establishing an foreign exchange spot and forward market which supports trading to the proper settlement date for the target financial transactions; and
performing an exchange clearing relationship that facilitates the integration of a foreign exchange market with another financial product market.

49. The system of claim 48 further including deriving a foreign exchange forward market by calculating implied markets from related markets;
adding the implied liquidity to original liquidity for each market; and
matching trades.

50. The system of claim 49 further comprising requiring foreign exchange market makers to contribute foreign exchange forwards with the appropriate settlement date for the target market.

51. The system of claim 49 further including further exposing the financial product in multiple currency markets by:
defining the market as a product having a numerator and a denominator; calculating implied cross rates from existing foreign exchange markets to the denominator of the market; and
restricting the market from cross rate calculations that would place it in the numerator of the biproduct.

52. The system of claim 48 further including deriving a foreign exchange forward market by defining a forward order type and a swap order type and their relationship to a spot transaction and using a date hierarchy to augment the priority and process of matching.

53. The system of claim 52 further comprising requiring foreign exchange market makers to contribute foreign exchange forwards with the appropriate settlement date for the target market.

54. The system of claim 52 further including further exposing the financial product in multiple currency markets by:
defining the market as a product having a numerator and a denominator; calculating implied cross rates from existing foreign exchange markets to the denominator of the market; and
restricting the market from cross rate calculations that would place it in the numerator of the biproduct.

55. The system of claim 48 further comprising the exchange serving as the intermediary between transactions between constituent markets.

56. The system of claim 55 further comprising confirming the transaction representing the financial market exposed in a foreign currency to the external customer as a single trade ticket.

57. The system of claim 55 further wherein, if the currency payment for the transaction is a margined transaction, the currency payment reflecting the margin amount and not the total notional amount, generally by executing a percentage of the notional value of the principal market trade.

58. A system to transform a cleared foreign exchange forward market into a futures market comprising:
establishing a foreign exchange forward market that supports trading to the same settlement date as foreign exchange futures;
establishing an exchange clearing relationship which facilitates the integration of a cleared foreign exchange forward market with a foreign exchange futures market; and
defining a relationship between a futures market and a cleared forward market and thereby defining a system to link liquidity via implied markets.

59. The system of claim 58 further including defining a relationship between futures and forward markets.

60. The system of claim 59 further including defining a relationship between futures and forward markets of the form:
$$FX Future \frac{{P}_{i}}{{P}_{j}} = FX Forward \frac{{P}_{i}}{{P}_{j}} or , \\ FX Future \frac{{P}_{i}}{{P}_{j}} = FX Forward \frac{{P}_{i}}{{P}_{x}} \times FX Forward \frac{{P}_{x}}{{P}_{j}}$$

61. The system of claim 58 further including defining a set of rounding rules.

62. The system of claim 61 further including defining a set of rounding rules wherein forward quantities are rounded down into denominations of the futures contract.

63. The system of claim 62 further wherein implied futures bid prices are rounded down.

64. The system of claim 62 further wherein implied futures offer prices are rounded up.

65. The system of claim 61 further including defining a set of rounding rules wherein forward prices are rounded into proper format and number of decimals as specified in the futures contract.

66. The system of claim 65 further wherein implied futures bid prices are rounded down.

67. The system of claim 65 further wherein implied futures offer prices are rounded up.

68. The system of claim 58 further wherein, upon matching a futures order, the returned forward transaction quantities reflecting the cash flows of the corresponding futures trade.

69. The system of claim 68 further wherein, upon matching a futures order, the returned forward transaction price is the transformed, unrounded futures price.

70. The system of claim 68 further comprising transforming futures quantities into numerator and denominator quantities of a forward contract.

71. The system of claim 68 further comprising rounding futures prices into proper format and number of decimals per convention in the forward market.

72. The system of claim 71 further comprising rounding implied forward bid prices down.

73. The system of claim 71 further comprising rounding implied forward offer prices up.

74. The system of claim 58 further wherein, upon matching a forward order, the returned future transaction quantity reflecting the same amount of currency contracts as equivalent to the amount of currency in the forward transaction.

75. The system of claim 74 further wherein, upon matching a forward order, the returned futures transaction price is the original futures price, with any residual currency amount, accruing to the exchange.

76. The system of claim 58 further including creating a database of external market conventions to reconcile with local standards and conventions.
